(19) United States
(12) Patent Application Publication
(10) Pub. No.: US 2018/0059651 A1
(43) Pub. Date: Mar. 1, 2018

(54) INFORMATION COLLECTION SYSTEM

(71) Applicant: SMART-FOA, Saitama (JP)

(72) Inventor: Masaharu OKU, Saitama (JP)

(21) Appl. No.: 15/556,757

(22) PCT Filed: Feb. 15, 2016
(86) PCT No.: PCT/JP2016/054240

§ 371 Date: Sep. 8, 2017

(30) Foreign Application Priority Data
Mar. 13, 2015 (JP) 2015-050328

(51) Int. Cl. G05B 19/418; G05B 23/02; G06F 17/30; G06F 11/30; G05B 15/02; G06Q 50/04

(52) U.S. Cl. CPC G05B 19/4183; G05B 23/0208; G06Q 50/04; G06F 11/3037; G05B 15/02; G06F 17/30312

(57) ABSTRACT

Provided is an information collection system reducing a computer load and a network load. An information collection system 1 includes a data stock device 1b and an event information creating device 1a connected via a network N. The data stock device 1b includes a management area 11 storing data flowing through the network N in a prescribed memory area according to the types of the data, and a change monitoring unit 16 monitoring a data change in the prescribed memory area of the management area 11. When the change monitoring unit 16 detects the data change, a plurality of data stored in the prescribed memory area 11 are collected, and transmitted to the event information creating device 1a. The event information creating device 1a collects the plurality of data received from the data stock device 1b as a series of data set, and creates event information 400.

### TECHNICAL FIELD

The present disclosure relates to an information collection system that collects data created at a factory, an office, and the like.

### BACKGROUND ART

In factories, and offices, etc., various facilities are in operation, and these facilities output observation data, and job-site data indicating observation result to the facility, a work, or a material, such as error information and status information. The job-site data is valuable information that contributes to the operation management of factories and offices, quality management of products, and administration management, etc.

However, the job-site data directly output from the facility has no secondary or tertiary meaning other than direct meanings, such as a code or a simple observation value, a place of occurrence, and a date and time of occurrence. Hence, conventionally, information obtained at job-site level is interpreted in sequence at each layer until reaching the management and administration level, and the job-site data is changed to event information having the secondary and tertiary meanings, and this event information is utilized at each level.

Therefore, the applicant has proposed an information collection system capable of automatically creating event information from job-site data which occur in huge amount every day, as disclosed in JP 2012-234496 A. This information collection system creates event information by adding supplementary information to the job-site data. Consequently, from the user side, it seems as if the event information, in which necessary details are directly and clearly described, is occurring, and at the time at which the event information arrives, the secondary and tertiary meanings and details of the event information can be understood without an interpretation work.

### CITATION LIST

### PATENT LITERATURES

Patent Document 1: JP 2012-234496 A

### SUMMARY OF INVENTION

### Technical Problem

When the job-site data and the supplementary information newly occur, the information collection system built in commercially available level stocks the job-site data and the supplementary information in a data stock device, and an event information creating device on a network actively accesses the data stock device, inquires for the occurrence of the job-site data and the supplementary information, requests a searching, requests a collection, receives the job-site data and the supplementary information, and creates the event information.

That is, the data stock device is functioned as a file server. In this case, the event information creating device also needs to monitor the data stocked by the data stock device in addition to the creation of the event information, and the load to the event information creating device is quite large. In addition, the inquiry to the data stock device, the search request, and the collection request by the event information creating device have a great impact to the network traffic.

When, for example, the information collection system collectively manages data occurred in the factories and the offices of multinational company in each country, the occurrence frequency of the new job-site data and supplementary information is enormous, and when the event information creating device attempts to access in accordance with the frequency, the load to the event information creating device and the network traffic are quite large.

The present disclosure has been made in order to address the technical problems of the conventional technologies, and an objective s to provide an information collection system that reduces a computer load and a network load.

### Solution to Problem

An information collection system according to the present disclosure includes a data stock device and an event information creating device connected via a network,

in which the data stock device includes:

data storing units that store data flowing through the network in a prescribed memory area in accordance with types of the data;

monitoring units that monitor a data change in the prescribed memory area of the data storing units;

information obtaining units that collect a plurality of the data stored in the prescribed memory area of the data storing units when the monitoring units detects the data change; and

first transmitting units that transmit the plurality of the data collected by the information obtaining units to the event information creating device, and

in which the event information creating device includes:

creating units that gather the plurality of the data received from the data stock device as a series of data set to create event information.

The data stock device may include monitoring target storing units that stores monitoring target information indicating the prescribed memory area monitored by the monitoring units; and the monitoring units may monitor the data change in the memory area indicated by the monitoring target information.

The data stock device may include obtaining target storing units that store obtaining target information indicating the prescribed memory area storing data collected by the information obtaining units; and the information obtaining units may obtain all data in the memory area indicated by the obtaining target information.

The event information creating device may further include:

dictionary storing units that store dictionary data defining the types of the plurality of the data configuring the event information; and

second transmitting units that transmit, in advance, the type information of the plurality of the data configuring the event information to the data stock device,

the data stock device may further include:

guide storing units that store obtaining target information on the memory area storing the data identified by the type information,

in which the information collecting units collect the plurality of the data based on the obtaining target information corresponding to the type information received from the event information creating device.

The above information collection system may be connected to, via the network, a data occurrence device occurring job-site data, and to a database storing supplementary information of each content, in which:

the data storing units of the data stock device may store the job-site data and the supplementary information in each of the prescribed memory area;

the information obtaining units of the data stock device may collect one or the plurality of the job-site data and one or the plurality of the supplementary information stored in the prescribed memory area of the data storing units; and

the creating units of the event information creating device may gather the one or the plurality of the job-site data and the one or the plurality of the supplementary information received from the data stock device as the series of data set to create the event information.

Time stamp data may be added to the job-site data; and

the monitoring units of the data stock device may monitor a data change in the time stamp data stored in the prescribed memory area in the job-site data stored in the data storing units.

The data storing units of the data stock device may store the supplementary information indicating a lot number of a product;

the monitoring units may monitor the supplementary information indicating the lot number of the product; and

the information obtaining units may collect the job-site data related to a same lot number, and stored in the prescribed memory area of the data storing units.

The data storing units of the data stock device may store the supplementary information indicating a model number of a product;

the monitoring units may monitor the supplementary information indicating the model number of the product; and

the information obtaining units collects the job-site data related to the product with a same model number, and stored in the prescribed memory area of the data storing units.

The monitoring units of the data stock device may monitor a data change in a plurality of the prescribed memory areas of the data storing units; and

the information obtaining units of the data stock device may collect the plurality of the data stored in the prescribed memory area of the data storing units when the monitoring units detects any data change.

### Advantageous Effects of Invention

According to the present disclosure, the event information creating device does not need to give an inquiry, a search request, and a transmission request one by one to the data stock device regarding the stocked data, and necessary and sufficient data to create the event information autonomously comes from the data stock device. Hence, a reduction of the load to the event information creating device, and a reduction of the network traffic can be achieved.

### BRIEF DESCRIPTION OF DRAWINGS

FIG. 1 is a block diagram illustrating a network structure including an information collection system according to a first embodiment;

FIG. 2 is a conceptual diagram illustrating event information;

FIG. 3 is a block diagram illustrating a detailed functional structure of a data stock device according to the first embodiment;

FIG. 4 is a block diagram illustrating a detailed functional structure of an event information creating device according to the first embodiment;

FIG. 5 is a schematic diagram illustrating a memory area in the information collection system;

FIG. 6 is a flowchart illustrating managing destination determining operation for job-site data according to the first embodiment;

FIG. 7 is a flowchart illustrating managing destination determining operation for supplementary information according to the first embodiment;

FIG. 8 is a flowchart illustrating an operation of obtaining the job-site data and the supplementary information in response to a change in data that is a monitoring target according to the first embodiment;

FIG. 9 is a flowchart illustrating an operation of creating event information from the job-site data and the supplementary information according to the first embodiment;

FIG. 10 is a flowchart illustrating an entire operation of the information collection system according to the first embodiment;

FIG. 11 is a first explanatory diagram illustrating a first application example of the information collecting system;

FIG. 12 is a second explanatory diagram illustrating the first application example of the information collecting system;

FIG. 13 is a third explanatory diagram illustrating the first application example of the information collecting system;

FIG. 14 is a first explanatory diagram illustrating a second application example of the information collecting system;

FIG. 15 is a second explanatory diagram illustrating the second application example of the information collecting system;

FIG. 16 is a third explanatory diagram illustrating the second application example of the information collecting system;

FIG. 17 is a block diagram illustrating a network structure including an information collecting system according to the second embodiment;

FIG. 18 is a schematic diagram illustrating dictionary data;

FIG. 19 is a block diagram illustrating a detailed structure of the information collection system according to the second embodiment;

FIG. 20 is a block diagram illustrating a detailed structure of a dictionary editing device according to the second embodiment;

FIG. 21 is a block diagram illustrating a detailed structure of an event information creating device according to the second embodiment;

FIG. 22 is a block diagram illustrating a detailed structure of a data stock device according to the second embodiment;

FIG. 23 is a schematic diagram illustrating a guide;

FIG. 24 is a flowchart illustrating a setting operation for collection by the information collection system according to the second embodiment; and

FIG. 25 is an explanatory diagram illustrating an application example of the information collection system according to the second embodiment.

### DESCRIPTION OF EMBODIMENTS

### First Embodiment

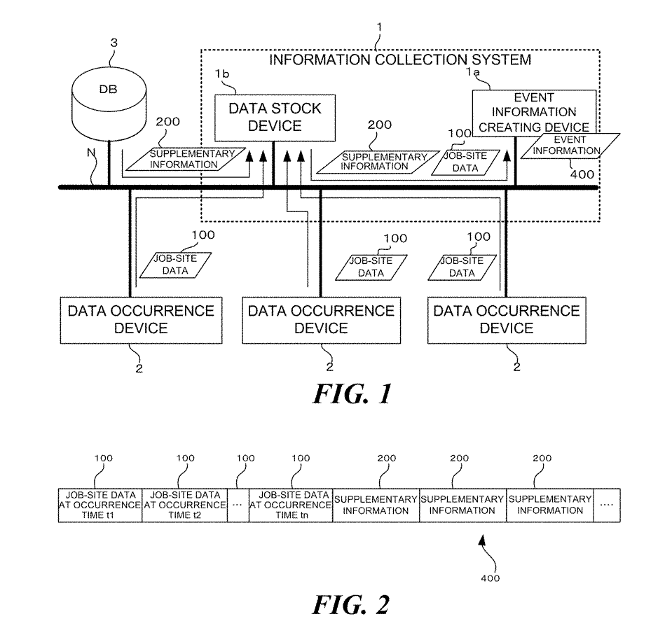

An information collection system according to a first embodiment will be described in detail with reference to the figures. FIG. 1 is a block diagram illustrating a network structure including an information collection system 1 according to this embodiment. The information collect on system 1 includes an event information creating device 1a, and a data stock device 1b. The event information creating device as and the data stock device 1b are connected to a common network N. One or more data occurrence device 2 and database 3 are also connected to the network N.

The event information creating device 1a, the data stock device 1b, the data occurrence device 2, and the database 3 each include a computer, and also a processor, a memory, such as an HDD or a RAM storing applications, and a network adapter. The event information creating device 1a and the data stock device 1b are each a single computer or a combination of a plurality of computer elements, such as a server and a router connected to the network N. The database 3 is a separate computer element which is integrated with the information collection system 1 or distributed over the network N. The data occurrence device 2 is a device having a function of monitoring facilities such as FA operated in a factory or in an office, and includes, for example, a programmable logic controller (PLC), a BCR, an RFID, a Pane CON, a mobile terminal, a web camera, and various sensors.

The network N is a communication infrastructure for transmitting and receiving data and commands converted into electric signals, and conforms to wired communication protocols such as IEEE 802.3, wireless communication protocols defined by IEEE 802.11, and other protocols. For example, the network is a communication line, such as a wired LAN network, a wireless LAN network, the Internet network, or a dedicated line, or a combination thereof.

This network N is divided into a plurality of physical and virtual LAN segments, and the data occurrence device 2, the event information creating device 1a, the data stock device 1b, and the database 3 may be installed so as to each belong to different segments. However, it is necessary that data transmission and reception are enabled between the data occurrence device 2 and the data stock device 1b, between the database 3 and the data stock device 1b, and. between the data stock device 1b and the event information creating device 1a.

In the network N, the data occurrence device 2 causes job-site data 100 to occur. The job-site data 100 is an observation result of facility monitored by the data occurrence device 2. For example, the job-site data 100 is observation data and status information indicating the observation details such as a temperature value and an operation status, and error information indicating an observation error. The job-site data 100 is created by a detection of various events or a periodical observation by the data occurrence device, has various formats depending on the data occurrence device 2, such as image data, sound data, and character string data, and has various expression forms like compression format depending on the data occurrence device 2. This job-site data 100 may be a user input. A mobile terminal may be connected to the network N, and the job-site data 100 may be input with the mobile terminal as a user interface.

The data occurrence device 2 adds, to the jobsite data 100, TCP and IP headers including the IP address of the information collection system 1 and the port number of the information collection application, and transmits them to the network N. The transmission timing is at the time of an occurrence of the event, or a predetermined cycle like day by day based on an assumption on the utilization of the system.

The information collection system 1 creates event information 400 from the job-site data 100. As illustrated in FIG. 2, the event information 400 is a single data set including the job-site data 100 and the various types of supplementary information 200, that is, variable length data obtained by linking the jobsite data 100 and the plurality of supplementary information 200 in series, and is described in, for example, an XML language. The supplementary information 200 is added in accordance with the types and. details of the job-site data 100. The job-site data 100 collected in the event information 400 is one type or the plurality of types, or the same type or different types having different occurrence clock times.

The supplementary information 200 has the primary details that is background information of an event which is an occurrence of the job-site data 100. The background information is information necessary for analyzing and evaluating an event at layers, such as the job-site, a management, and an operation of an organization such as a company, directly or indirectly indicates the cause of the occurrence of the job-site data 100, and adds, to the event information 400, the meaning and details that cannot be derived by the job-site data 100 alone in combination with the job-site data 100. For example, the supplementary information 200 includes a process assisting material required for processing the job-site data 100, a comparison target material to be compared with the job-site data 100, an analysis assisting material giving an effect to the analysis, and an evaluation assisting material giving an effect to the evaluation of the analysis result.

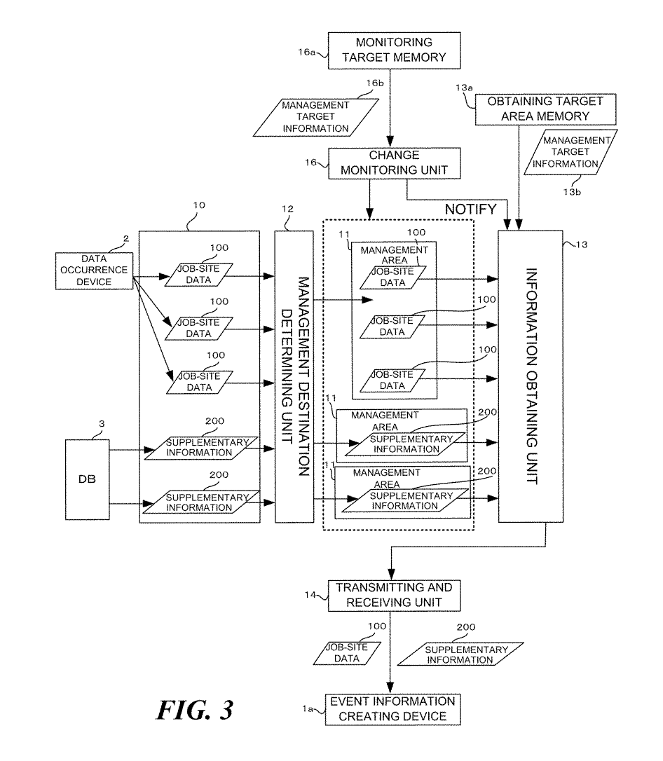

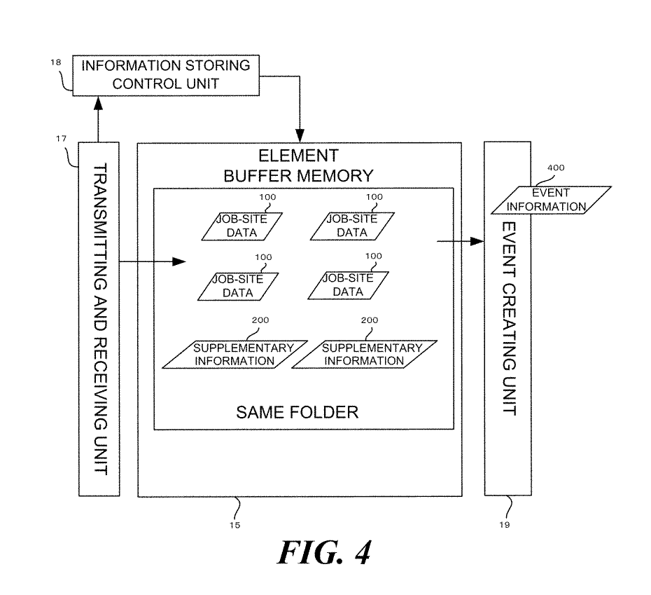

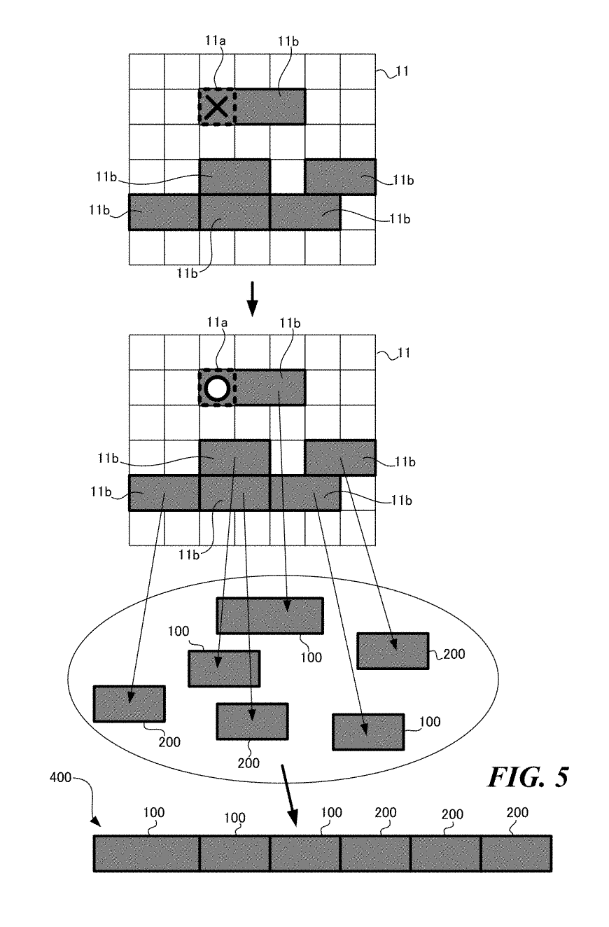

FIG. 3 is a block diagram illustrating the detailed functional structure of the data stock device 1b. FIG. 4 is a block diagram illustrating a detailed functional structure of the event information creating device 1a. FIG. 5 is a schematic diagram illustrating a memory area of the information collection system 1. As illustrated in FIG. 3, the data stock device it includes a temporary memory 10, a management area 11, a management destination determining unit 12, a change monitoring unit 16, an information obtaining unit 13, and a transmitting and receiving unit 14. As illustrated in FIG. 4, the event information creating device 1a includes a transmitting and receiving unit 17, an element buffer memory 15, an information storing control unit 18, and an event creating unit 19.

As illustrated in FIG. 5, this data stock device 1b stocks the job-site data 100 and the supplementary information 200 in the management area 11 in accordance with the source of the information, monitors a prescribed monitoring target memory area 11a, and when there is a change in the monitored memory area 11a, takes out the job-site data 100 and the supplementary information 200 stocked in a prescribed obtaining target memory area 11b, and gives to the event creating device 1a. The event creating device 1a creates event information 400 from the given job-site data 100 and supplementary information 200. The term change refers to the storage of data into the memory area 11a in which no data has been stored, the change in the stored data, and the deletion of the stored data.

In the data stock device 1b, the temporary memory 10 is a queue of the job-site data 100 occurred by the data occurrence device 2, and a queue of the supplementary information 200 stored in the database 3, and is a memory area for awaiting the transfer to the management area 11. Each management area 11 is a memory area, reserved in advance for each data occurrence device 2 and for each types of supplementary information 200, and the job-site data 100 and supplementary information 200 are transferred from the temporary memory 10. A part of each management area 11 is specified as the obtaining target memory area 11b.

The management destination determining unit 12 includes a processor, and sorts the job-site data 100 and the supplementary information 200 stored in the temporary memory 10 into each management area 11. For example, the management destination determining unit 12 specifies the source of the job-site data 100 based on a transmission source IP address or a port number added to the header, etc., or specifies based on a connection port of the cable. Accordingly, the management destination determining unit 12 stores the job-site data 100 in the management area 11 in accordance with the source of the information. In addition, when, for example, the supplementary information 200 is retrieved from the database 3, the management destination determining unit 12 specifies the source of the supplementary information 200 based on the types of information, and stores the supplementary information 200 in the management area 11 in accordance with the source of the information.

The change monitoring unit 16 includes a processor and a memory, and monitors a change in data stored in the monitoring target memory area 11a. This change monitoring unit 16 includes a monitoring target information memory unit 16a. This monitoring target information memory unit 16a stores monitoring targeting information 16b for identifying data which is the monitoring target for change. The change monitoring unit 16 monitors a change in data identified by the monitoring target information 16b. The monitoring target information 16b is, for example, an address of the monitoring target memory area 11a. The change monitoring unit 16 monitors the change in the data stored in the memory. area of the address indicated by the monitoring target information 16b.

The information obtaining unit 13 includes a processor, and obtains the job-site data 100 and the supplementary information 200 at a timing at which a change occurs in the data stored in the monitoring target memory area 11a. This information obtaining unit 13 includes an obtaining target area memory unit 13a. The obtaining target area memory unit 13a includes a memory, and stores the obtaining target information 13b that identifies data to be obtained. The obtaining target information 13b is, for example, the address of the obtaining target memory area 11b in which the data to be obtained is stored, and stores the respective addresses of the job-site data 100 and the plurality of the supplementary information 200 to be associated to the same event information.

The transmitting and receiving unit 14 of the data stock device 1b mainly includes a network adapter, and transmits the job-site data 100 and the plurality of supplementary information 200 obtained by the information obtaining unit 13 and to the event creating device 1a via the network N. The transmitting and receiving unit 17 of the event information creating device 1a mainly includes a network adapter, and receives the job-site data 100 and the plurality of supplementary information transmitted from the data stock device 1b via the network N.

In the event creating device 1a, the element buffer memory 15 includes a memory, and stores the job-site data 100 and the plurality of supplementary information 200 obtained by the information obtaining unit 13. The job-site data 100 and the plurality of supplementary information 200 derived from the same obtaining target information 13b are collectively stored in the same folder. The information storing control unit 13 includes a processor, creates a folder in the element buffer memory 15, and stores the job-site data 100 and the plurality of supplementary information 200 derived from the same obtaining target information 13b in the same folder.

The event creating unit 19 includes a processor, and creates the event information 400 from the job-site data 100 and the supplementary information 200 in the element buffer memory 15. The event creating unit 19 gathers the plurality of job-site data 100 and supplementary information 200 stored in the same folder into the single event information 400. More specifically, the event creating unit 19 edits the plurality of the job-site data 100 and the supplementary information 200 stored in the same folder into a series of data set, and sets this data set as the event information 400.

(Operation)

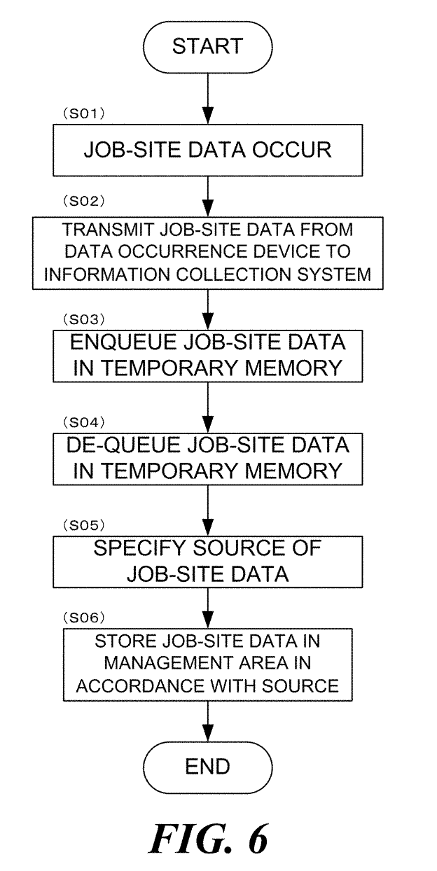

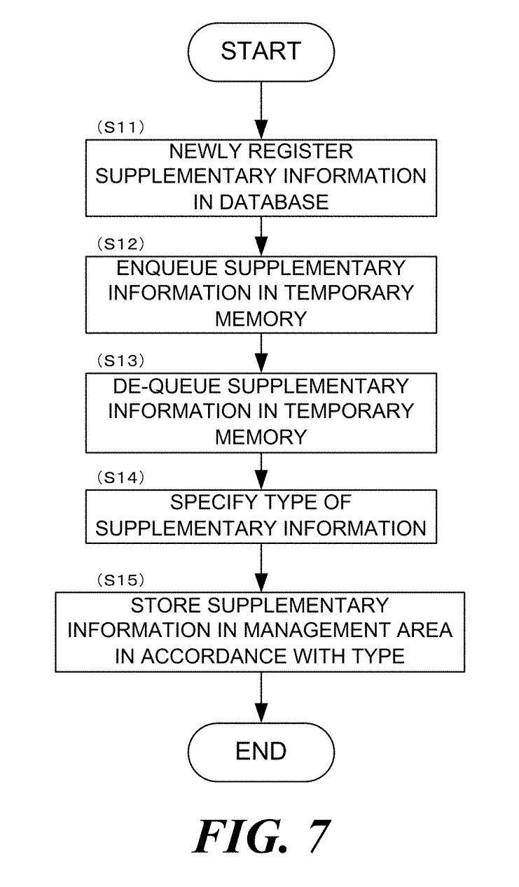

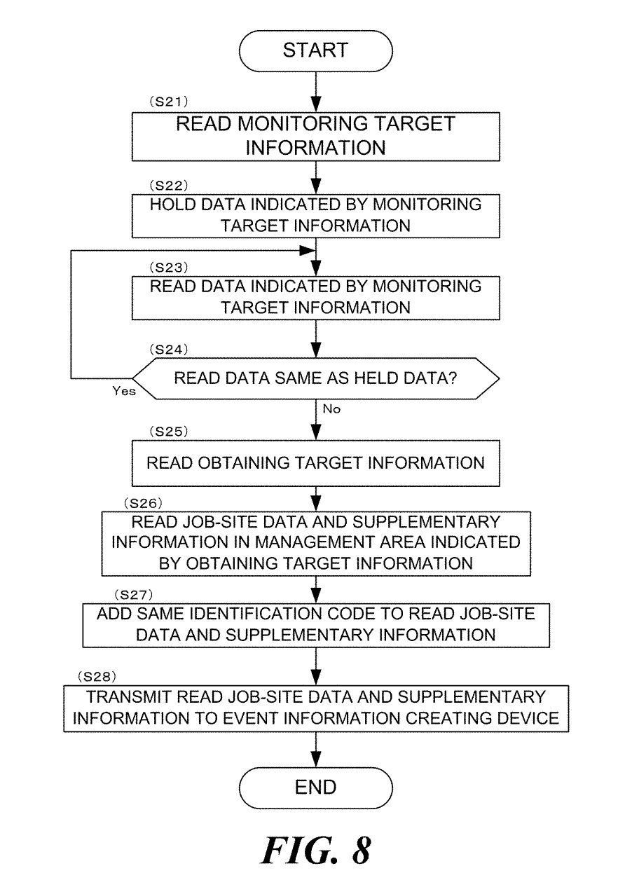

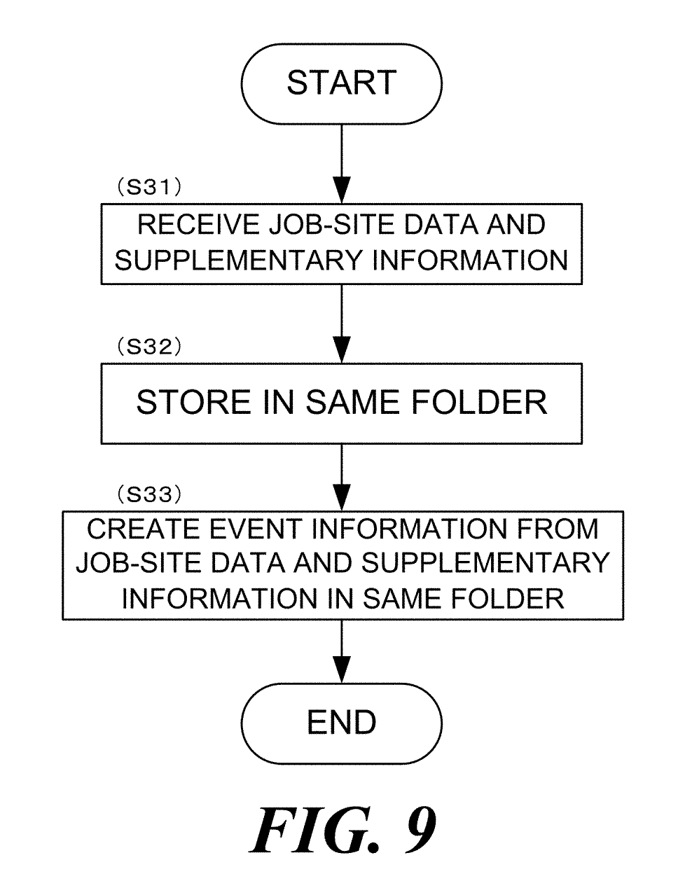

The operation of this information collection system 1 will be described in detail with reference to FIGS. 6 to 9. FIG. 6 is a flowchart illustrating a management destination determining operation for the job-site data 100. FIG. 7 is a flowchart illustrating the management destination determining operation for the supplementary information 200. FIG. 8 is a flowchart illustrating an operation of obtaining the job-site data 100 and the supplementary information 200 in response to a change in data to be monitored. FIG. 9 is a flowchart illustrating the operation of creating the event information 400 from the job-site data 100 and the supplementary information 200.

(Determination of Management Destination for Job-Site Data 100)

As illustrated in FIG. 6, when the job-site data 100 is occurred at the data occurrence device 2 (step S01), the data occurrence device 2 transmits the job-site data 100 to the information collection system 1 (step S02). The information collection system 1 enqueues the received job-site data 100 in the temporary memory 10 (step S03).

The management destination determining unit 12 periodically or immediately dequeues the job-site data 100 from the temporary memory 10 (step S04), specifies the source of the information of the job-site data 100 (step S05), and stores the dequeued job-site data 100 in the management area 11 in accordance with the source of the information (step S06).

The source of the information is specified by, for example, a transmission source address, a port number, or a socket added to the job-site data 100, and a connection port of the cable, etc. The management area 11 is distinguished based on the transmission source address, the port number, the socket, or the connection port of the cable. The management destination determining unit 12 stores the job-site data 100 in the management area 11 in accordance with the transmission source address, the port number, the socket, or the connection port of the cable.

(Determination on Management Destination for Supplementary Information 200)

As illustrated in FIG. 7, when the supplementary information 200 is newly registered in the database 3 (step S11), the newly registered supplementary information 200 is enqueued from the database 3 to the temporary memory 10 (step S12). The enqueuing of the supplementary information 200 may be performed immediately in response to the registration, or may be collectively performed periodically.

The management destination determining unit 12 dequeues the supplementary information 200 from the temporary memory 10 (step S13), specifies the types of the supplementary information 200 (step S14), and stores the dequeued supplementary information 200 in the management area 11 in accordance with type information 320 (step S15). For example, the supplementary information 200 is specified based on the attribute value on the database 3. The management area 11 is distinguished based on this attribute value. The management destination determining unit 12 stores the supplementary information 200 in the management area 11 in accordance with the attribute value.

(Information Obtainment)

As illustrated in FIG. 8, the change monitoring unit 16 reads the monitoring target information 16b from the monitoring target information memory unit 16a (step S21). When reading the monitoring target information 16b, the change monitoring unit 16 holds the data indicated by the monitoring target information 16b (step S22). Next, the change monitoring unit 16 periodically reads the data indicated by the monitoring target information 16b (step S23), and determines the difference between the read data and the held data (step S24).

When the read data and the held data are consistent with each other (step S24: YES), the change monitoring unit 16 returns the process to the step S23, and periodically repeats the determination in the step S24. Conversely, when the read data and the held data are different from each other (step S24: NO), the information obtaining unit 13 reads the obtaining target information 13b from the obtaining target area memory unit 13a (step S25). When reading the obtaining target information 13b, the information obtaining unit 13 reads the job-site data 100 and the supplementary information 200 stored in the management area 11 indicated by the obtaining target information 13b (step S26).

Next, the information obtaining unit 13 gives the same identification code to the read job-site data 100 and the supplementary information 200 (step S27), and the transmitting and receiving unit 14 transmits the job-site data 100 and the supplementary information 200 read by the information obtaining unit 13 to the event information creating device 1a via the network N (step S28).

(Creation of Event Information 400)

As illustrated in FIG. 9, the event creating device as receives the job-site data 100 and the supplementary information 200 transmitted from the data stock device 1b by the transmitting and receiving unit 17 (step S31). The information storing control unit 18 stores the job-site data 100 and the supplementary information 200 to which the same identification code are given in the same folder of the element buffer memory 15 (step S32). When the job-site data 100 and the supplementary information 200 are stored in the element buffer memory 15, the event creating unit 19 edits the job-site data 100 and the supplementary information 200 stored in the same folder as a single series of data set, and creates the event information 400 (step S33).

(Operation)

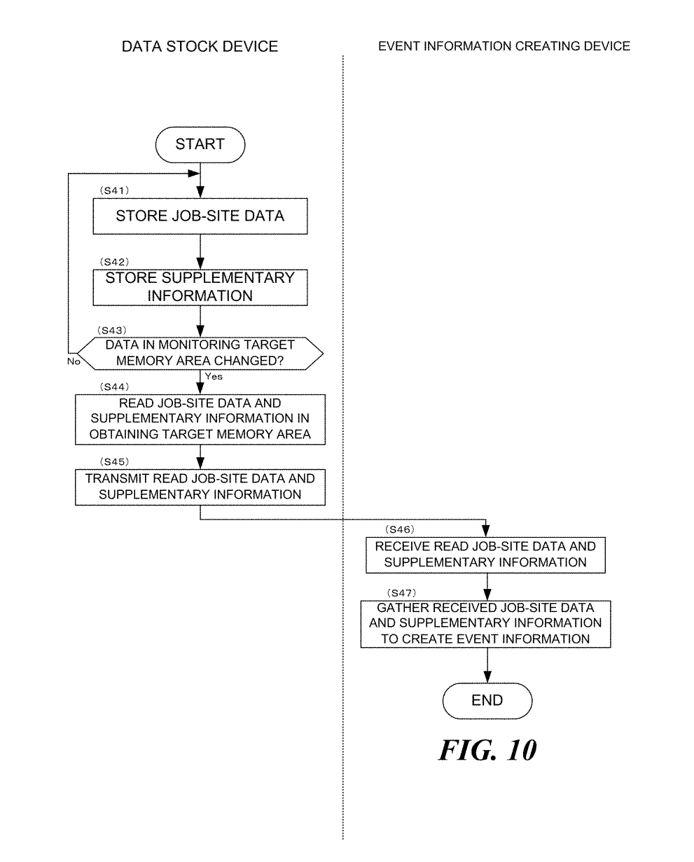

FIG. 10 is a flowchart illustrating the entire. operation of the information collection system 1. As illustrated in FIG. 10, the job-site data 100 occurred by the data occurrence device 2 is stored in the data stock device 1b (step S41), and the supplementary information 200 from the database 3 is stored in the data stock device 1b (step S42). The data stock device 1b monitors the monitoring target memory area 11a (step S43), and when the data in the monitoring target memory area 11a changes (step S43: YES), the data stock device 1b reads the job-site data 100 and the supplementary information 200 in the obtaining target memory area 11b (step S44), and transmits them to the event information creating device 1a (step S45).

When receiving the job-site data 100 and the supplementary information 200 (step S46), the event information creating device 1a gathers the received job-site data 100 and the supplementary information 200 into a single series of data set to create the event information 400 (step S47). As described above, the event information creating device 1a does not collect the job-site data 100 and the supplementary information 200, but from the event information creating device 1a, it seems as if the job-site data 100 and the supplementary information 200 are autonomously coming.

### FIRST APPLICATION EXAMPLE

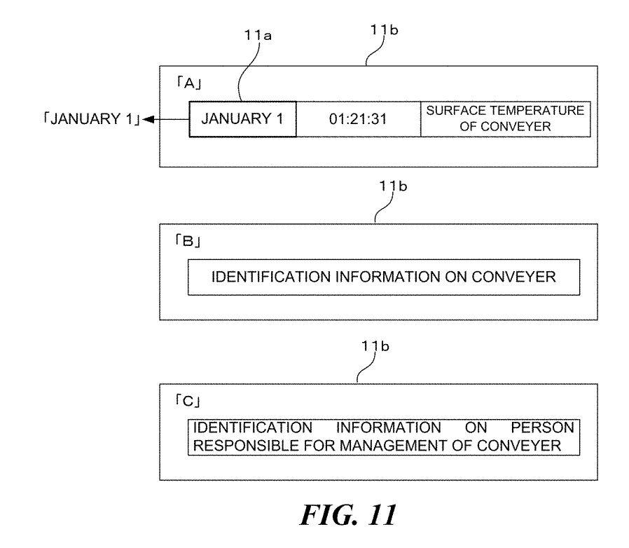

Hereinafter, the operation of the information collection system 1 will be described based on the first application example. Connected to the network N is a temperature sensor as the data occurrence device 2, and the temperature sensor periodically outputs numerical data of the surface temperature of the conveyer as the job-site data 100. As illustrated in FIG. 11, added to this numerical data is time stamp data indicating the time at which the job-site data 100 is occurred. The job-site data 100 output by the temperature sensor is enqueued in the temporary memory 10, and transferred to the management area 11 that is “A” associated with the temperature sensor one to one by the management destination determining unit 12.

Stored in the database 3 is character string data for identifying the conveyer as the supplementary information 200. In addition, stored in the database 3 is character string data for identifying a person responsible for the management of the conveyer. The supplementary information 200 for identifying this conveyer and the supplementary information 200 for identifying the person responsible for the management are enqueued in the temporary memory 10. The management destination determining unit 12 transfers the supplementary information 200 for identifying the conveyer to the management area 11 that is “B” associated with the supplementary information 200 for identifying the conveyer one to one. In addition, the management destination determining unit 12 transfers the supplementary information 200 for identifying the person responsible for the management to the management area 11 that is “C” associated with the supplementary information 200 for identifying the person responsible for the management one to one.

Stored in advance in the monitoring target information memory unit 16a is the monitoring target information 16b that is an address corresponding to the date portion of the time stamp data in the job-site data 100 transferred to the management area 11 that is “A”. The obtaining target information memory unit 13a stores the obtaining target information 13b that is addresses indicating the management area 11 that is “A”, the management area 11 that is “B”, and the management area 11 that is “C”.

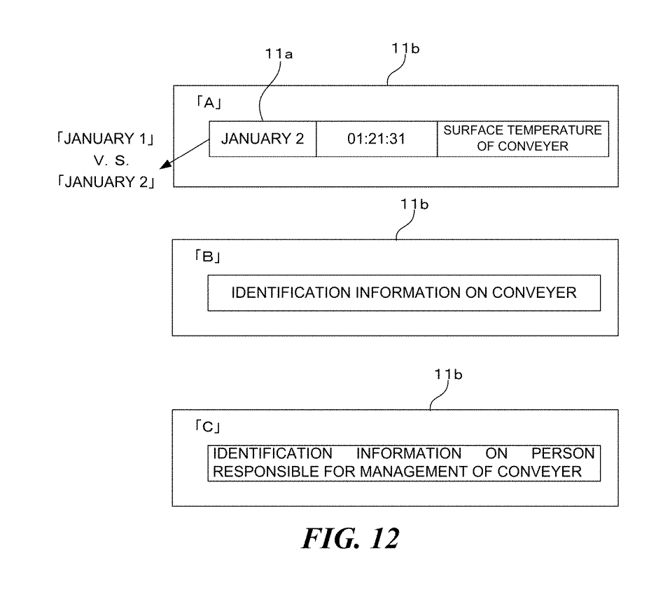

When the date data indicated by the monitoring target information 16b indicates “January 1st”, the change monitoring unit 16 holds the data that is “January 1st”, and compares this data with the data in the monitoring target memory area 11a indicated by the monitoring target information 16b. As illustrated in FIG. 12, when the date changes to “January 2nd”, and the temperature sensor creates the new job-site data 100, the data in the management area 11 that is “A” is updated to the job-site data 100 containing the date of “January 2nd”.

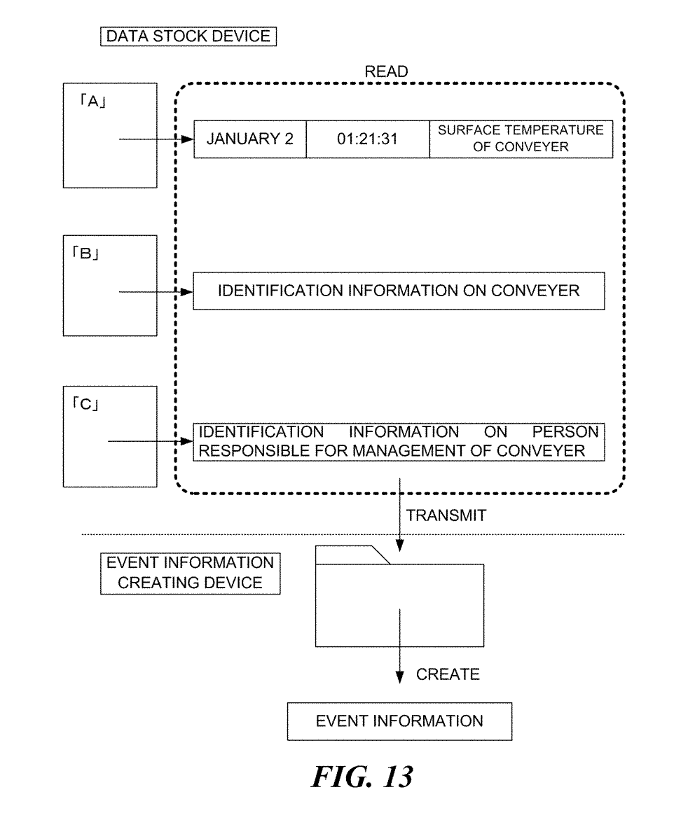

By this updated job-site data 100, the data in the monitoring target memory area 11a changes to “January 2nd” which is different from the data of “January 1st” held by the change monitoring unit 16. Hence, as illustrated in FIG. 13, the information obtaining unit 13 refers to the obtaining target information memory unit 13a, and reads all data stored in the management area 11 that is “A”, the management area 11 that is “B”, and the management area 11 that is “C”. That is, the information obtaining unit 13 reads, as the plurality of job-site data 100 and the plurality of supplementary information 200, the numerical data of the surface temperature of the conveyer dated “January 2nd” output by the temperature sensor, the information identifying the conveyer, and the information identifying the person responsible for management.

The transmitting and receiving unit 14 transmits the plurality of job-site data 100 and the plurality of supplementary information 200 obtained by the information obtaining unit 13 to the event information creating device 1a. The event information creating device 1a stores, as the plurality of job-site data 100 and the plurality of supplementary information 200, the numerical data of the surface temperature of the conveyer dated “January 2nd”, the information identifying the conveyer, and the information identifying the person responsible to management in the same folder.

The event information creating device 1a creates the event information 400 from all the numerical data of the surface temperature of the conveyer dated “January 1st”, the information identifying the conveyer, and the information identifying the person responsible for management stored in the same folder. That is, the event information 400 contains as a series of data set the numerical data of the surface temperature of the conveyer periodically occurred on January 1st in a day, the information identifying the conveyer, and the information identifying the person responsible for management on this day.

### SECOND APPLICATION EXAMPLE

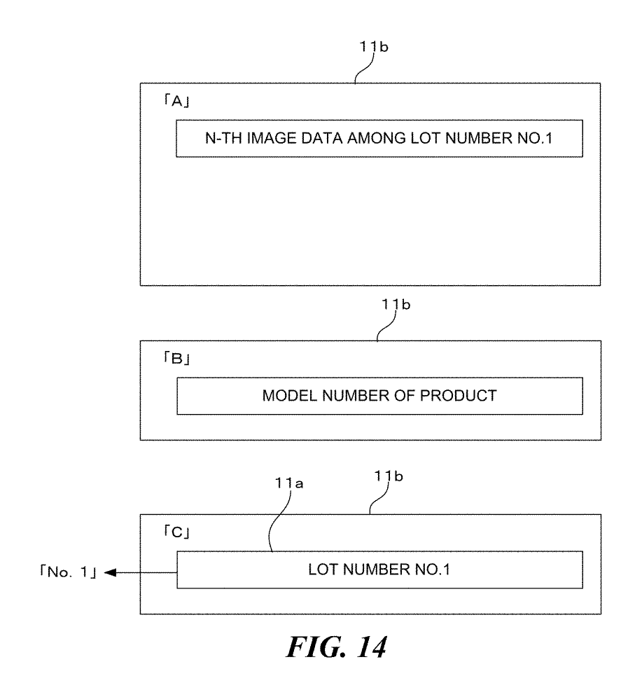

A second application example of the information collection system 1 will be described with reference to FIGS. 14 to 16. Connected to the network N is a camera that is the data occurrence device 2. The camera periodically outputs the image data obtained by imaging a product as the job-site data 100. As illustrated in FIG. 14, this image data is enqueued in the temporary memory 10, and is transferred to the management area 11 that is “A” associated with the temperature sensor one to one by the management destination determining unit 12.

In addition, stored in the database 3 is the model number of the product and the lot number thereof as the supplementary information 200. The supplementary information 200 indicating the model number of the product, and the supplementary information 200 indicating the lot number are enqueued in the temporary memory 10. The management destination determining unit 12 transfers the supplementary information 200 indicating the product model number to the management area 11 that is “B”. In addition, the management destination determining unit 12 transfers the supplementary information 200 indicating the lot number to the management area 11 that is “C”.

In addition, stored in advance in the monitoring target information memory unit 16a is the address of the management area 11 that is “C” as the monitoring target information 16b. Stored in the obtaining target information memory unit 13a are the addresses indicating the management area 11 that is “A”, the management area 11 that is “B”, and the management area 11 that is “C” as the obtaining target information 13b.

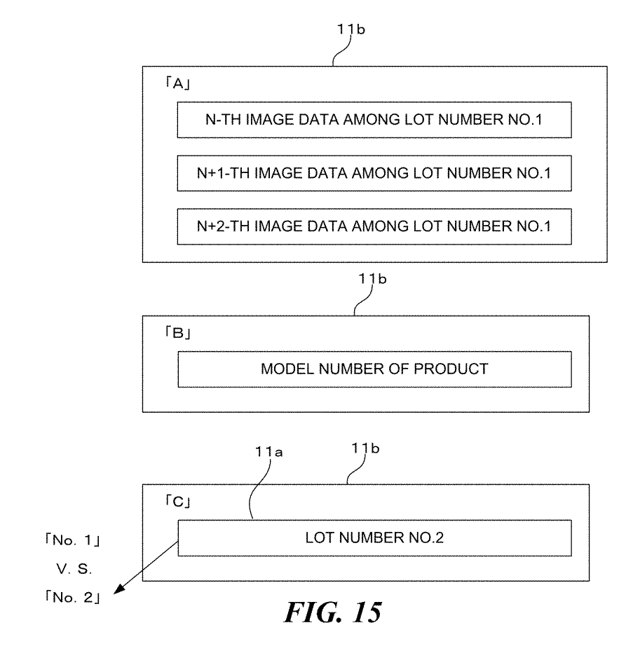

When the text data indicated by the monitoring target information 16b indicates “No. 1”, the change monitoring unit 16 holds the data that is “No. 1”, and compares with the data in the monitoring target memory area has indicated by the monitoring target information 16b. As illustrated in FIG. 15, when the lot number changes to “No. 2”, the supplementary information 200 stored in the management area 11 that is “C” is updated to “No. 2”.

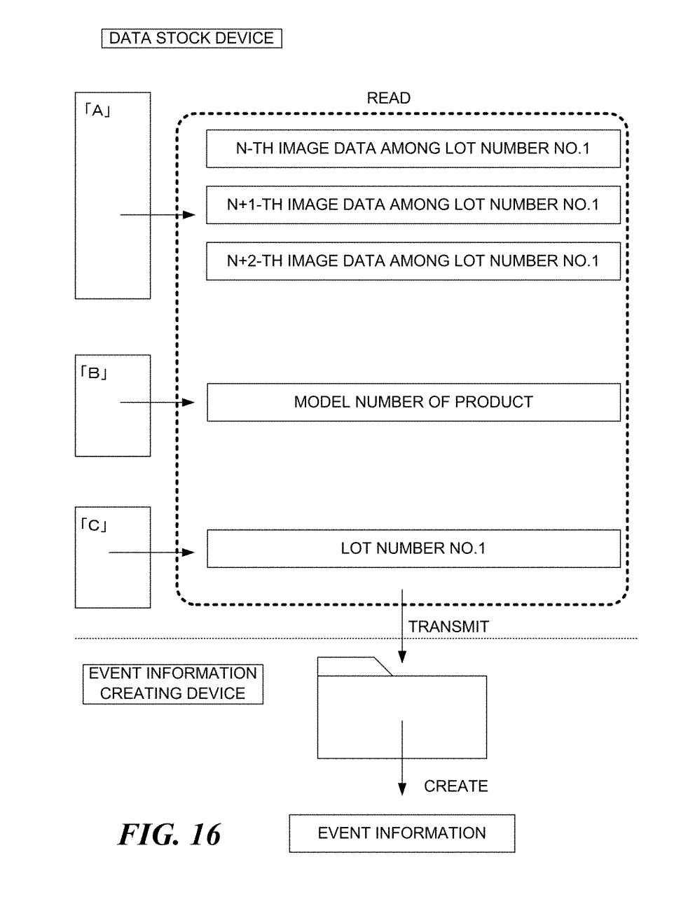

By this update, the data in the monitoring target memory area 11a is changed to “No. 2” which is different from the data that is “No. 1” held by the change monitoring unit 16. Hence, as illustrated in FIG. 16, the information obtaining unit 13 refers to the obtaining target information memory unit 13a, and reads ail data stored in the management area 11 that is “A”, the management area 11 that is “B”, and the management area 11 that “C”. That is, the information obtaining unit 13 reads, as the plurality of job-site data 100 and the plurality of supplementary information 200, all image data of products with the lot number of No. 1, the information identifying the product model number, and the information identifying the lot number.

The transmitting and receiving unit 14 transmits the plurality of job-site data 100 and the plurality of supplementary information 200 obtained by the information obtaining unit 13 to the event information creating device 1a. The event information creating device 1a stores, as the plurality of job-site data 100 and the plurality of supplementary information 200, the image data of the products having the lot number that is No. 1, the information indicating the lot number that is No. 1, and the model number of the product in the same folder. The event information creating device 1a creates event information that is a series of data set including all of the job-site data 100 and the supplementary information 200 stored in the same folder.

### THIRD APPLICATION EXAMPLE

The monitoring target information 16b may contain a plurality of information, and the plurality of monitoring target memory areas 11a may be provided. For example, the monitoring target information 16b indicates a monitoring target memory area 11a storing the supplementary information 200 indicating the lot number of a product, and a monitoring target memory area 11a storing the supplementary information 200 indicating the manufacturer of the component assembled with the product. The change monitoring unit 16 monitors both the lot number of the product and the manufacturer of the component assembled with the product as the supplementary information 200, and when either one of the supplementary information changes, the information obtaining unit 13 collects the data defined by the obtaining target information 13b, and the event information 400 is created by the event creating unit 19.

(Effects)

As described above, the information collection system 1 includes the data stock device 1b, and the event information creating device 1a. connected to each other via the network N. The data stock device 1b includes data storing units for storing data, such as the job-site data 100 and the supplementary information 200 flowing through the network N, in a prescribed memory area in accordance with the types of data. In this embodiment, the data storing units is a memory, and the data storing units is the management area 11 in this embodiment.

The data stock device 1b includes the change monitoring unit 16 monitoring a data change in the management area 11, and the information obtaining unit 13 collecting the plurality of data stored in the prescribed memory area of the data storing units when the data change is detected. The prescribed memory area that is obtainment source of the information obtaining unit 13 is the prescribed management area 11 in this embodiment. Next, the data stock device 1b transmits the plurality of data collected by the information obtaining unit 13 to the event information creating device 1a.

Hence, the event information creating device 1a may simply include the event creating unit 19 that creates the event information by collecting the plurality of data received from the data stock device 1b as a series of data set. That is, it is unnecessary to give an inquiry, a search request, and a transmission request one by one to the data server that is the data stock device 1b regarding the stocked data, and from the event information creating device 1a side, it seems as if necessary and sufficient data to create the event information 400 is autonomously coming from the data stock device 1b. Hence, it is possible to achieve the reduction of the load to the event information creating device 1a, and reduction of the traffic over the network N due to the unnecessity of an inquiry, a search request, and a transmission request.

In this embodiment, monitoring of the data change in the time stamp data stored in the prescribed memory area among the job-site data, and of the data change in the supplementary information 200 indicating the lot number of the product are described as examples. However, the present disclosure is not limited to such examples, and for example, the data change of the product model number may be adopted as appropriate as the monitoring target.

### Second Embodiment

Hereinafter, an information collection system according to a second embodiment will be described in detail with reference to the figures. The same reference numerals are given to the same structure and the same function as those of the first embodiment, and the detailed description thereof will not be repeated.

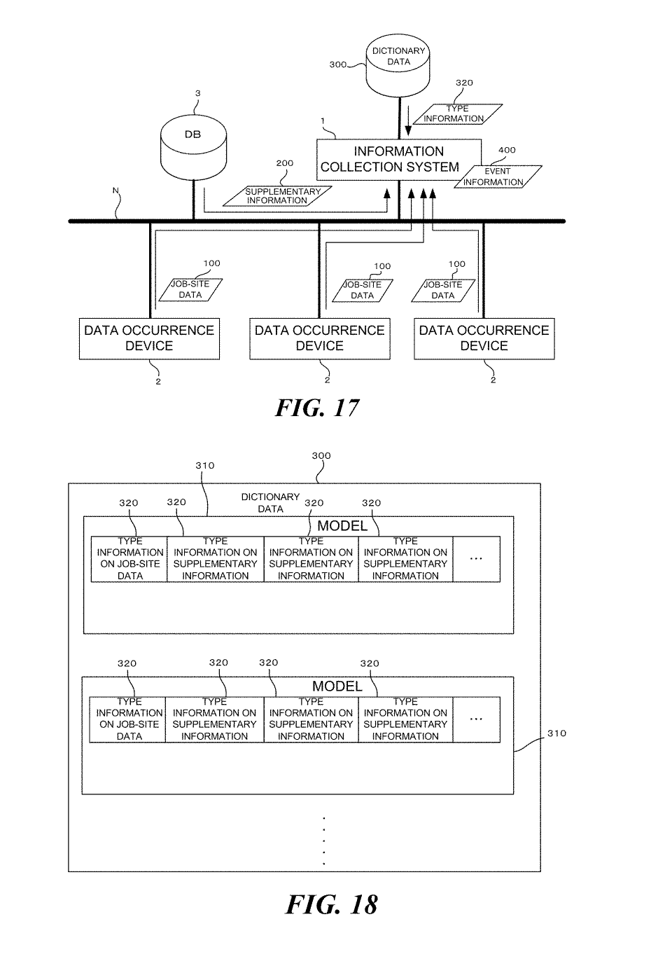

As illustrated in FIG. 17, this information collection system 1 includes dictionary data 300 in advance. As illustrated in FIG. 18, the dictionary data 300 records various models 310 of the event information 400. In each model 310, type information 320 are recited. The type information 320 indicates the type of information to be contained in the event information 400. The information collection system 1 collects the job-site data 100 or the supplementary information 200 corresponding to the type information 320 recited in the single model 310 into a single event information 400.

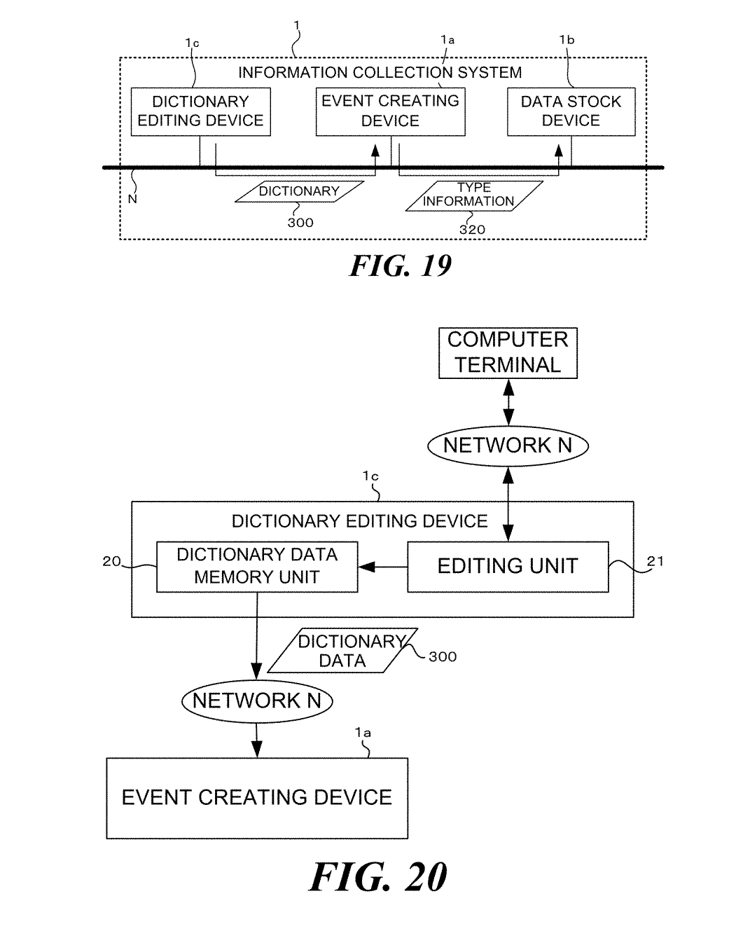

FIG. 19 is a block diagram illustrating the detailed structure of the information collection system 1. The information collection system 1 includes the event information creating device 1a, the data stock device 1b, and a dictionary editing device 1c.

As illustrated in FIG. 20, this dictionary editing device 1c includes a dictionary data memory unit 20 and an editing unit 21. The dictionary data memory unit 20 mainly includes a memory, and stores the dictionary data 300. The editing unit 21 mainly includes a processor and a network adapter, receives an editing request from the computer terminal of a collection requester, and edits the dictionary data 300 in accordance with the editing request. This editing unit 21 receives the editing requests, such as addition and deletion of the model 310, and addition and deletion of the type information 320 recited in the model 310.

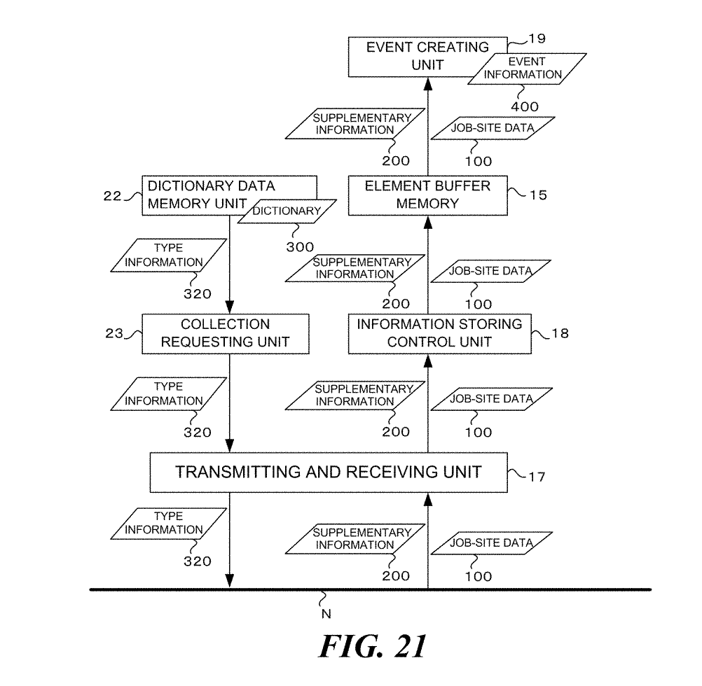

As illustrated in FIG. 21, the event information creating device 1a further includes a dictionary data memory unit 22 and a collection requesting unit 23. The dictionary data memory unit 22 includes a memory, and stores the dictionary data 300. The dictionary data 300 is edited in advance by the dictionary editing device 1c, and held. The event information creating device 1a copies the dictionary data 300 of the dictionary editing device 1c into the dictionary data memory unit 22.

The collection requesting unit 23 includes a processor and a network adapter, and requests the data stock device 1b to collect the job-site data 100 and the supplementary information 200. The collection requesting unit 23 reads the type information 320 recited in the model 310 of the dictionary data 300, and transmits them to the data stock device 1b.

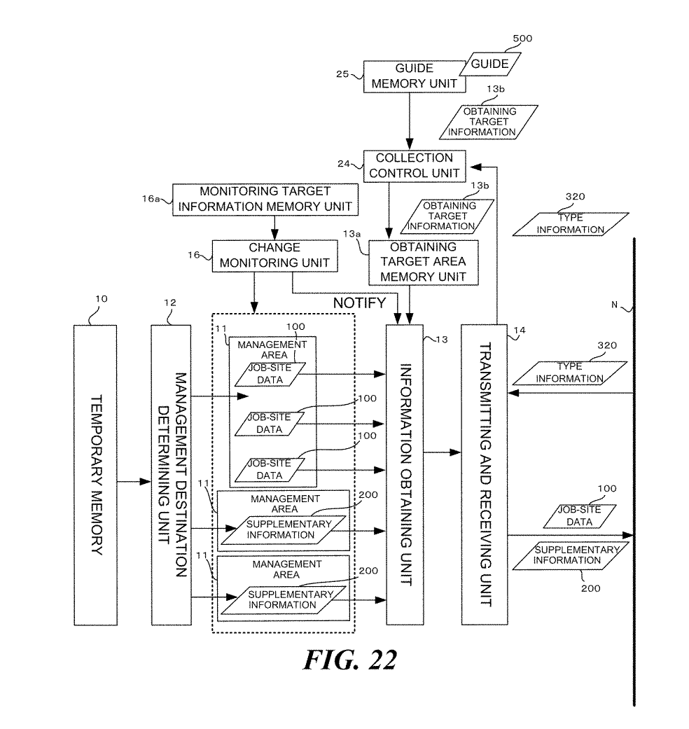

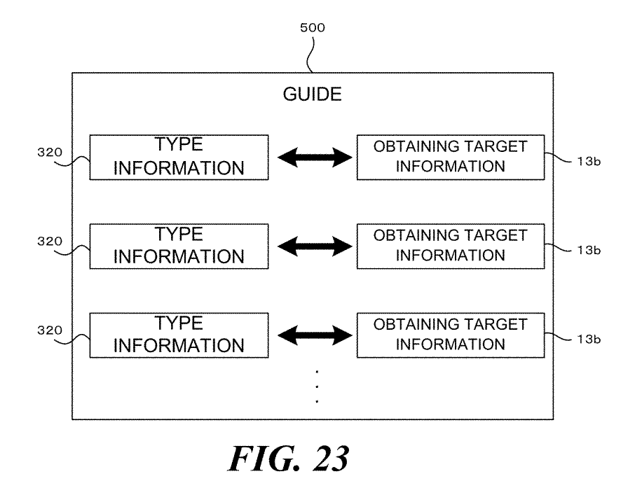

As illustrated in FIG. 22, the data stock device 1b further includes a collection control unit 24, and a guide memory unit 25. The guide memory unit 25 includes a memory, and stores a guide 500. As illustrated in FIG. 23, the guide 500 is a database that associates the type information 320 with obtaining target information 13b one to one. The collection control unit 24 reads the obtaining target information 13b associated with the type information 320 received from the event information creating device 1a, and stores in the obtaining target information memory unit 13a. When the change monitoring unit 16 detects a data change, the information obtaining unit 13 obtains the job-site data 100 and the supplementary information 200 in accordance with the obtaining target information 13b read by the collection control unit 24.

(Operation)

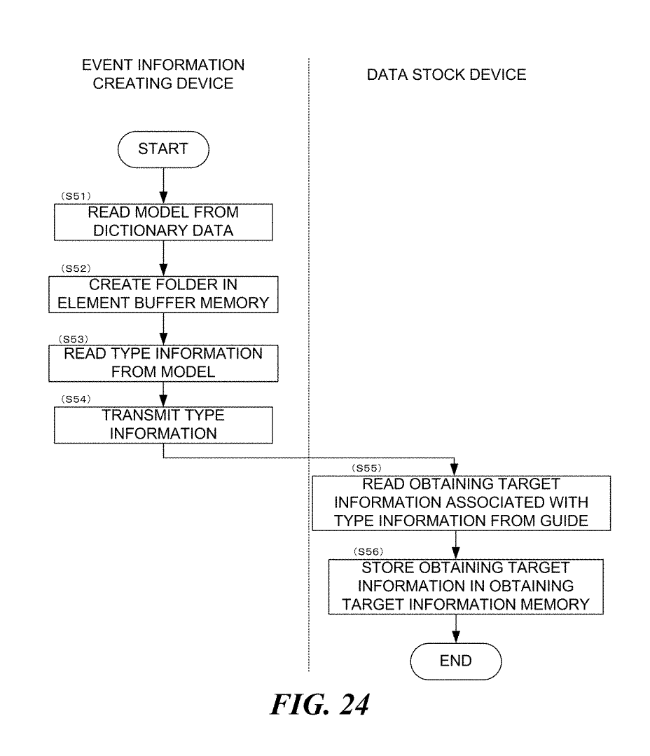

An operation unique to the information collection system 1 according to the second embodiment will be described. FIG. 24 is a flowchart illustrating a setting operation for the collection. As illustrated in FIG. 24, the collection requesting unit 23 reads the model 310 of the event information 400 from the dictionary data 300 stored in the dictionary data memory unit 16 (step S51). After reading the model 310, the information storing control unit 18 creates a single folder corresponding to the model 310 in the element buffer memory 15 (step S52). The collection requesting unit 23 reads the type information 320 from the read model 310 (step S53), and transmits them to the data stock device 1b (step S54).

In the data stock device 1a, the collection control unit 24 reads the obtaining target information 13b associated with the type information 320 from the guide 500 (step S55), and stores the obtaining target information 13b in the collection target information memory unit 13a (step S56).

(Action)

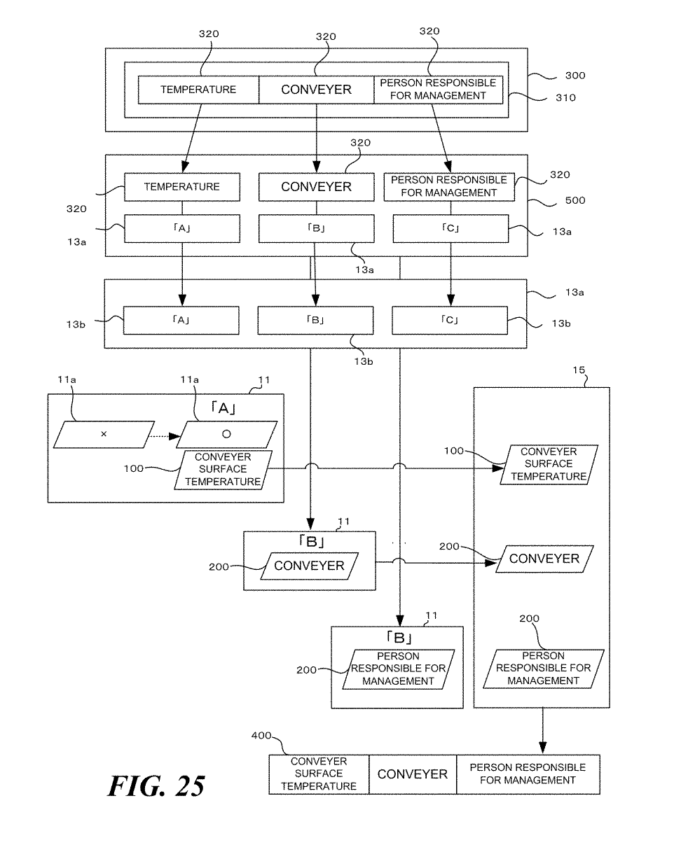

FIG. 25 illustrates a specific operation example of the information collection system 1 according to the second. embodiment. Recited in the single model 310 in the dictionary data 300 are the type information 320 indicating the surface temperature of the conveyer, the type information 320 indicating the identification of the conveyer, and the type information 320 indicating the identification of a person responsible for management. The collection requesting unit 23 reads those type information 320, and transmits them to the data stock device 1b.

The guide 500 stores the obtaining target information 13b indicating “A” that is the management area for the job-site data 100 indicating the surface temperature of the conveyer corresponding to the type information 320 indicating the surface temperature of the conveyer. The guide 500 also stores the obtaining target information 13b indicating “B” that is the management area 11 for the supplementary information 200 identifying the conveyer corresponding to the type information 320 indicating the identification of the conveyer. The guide 500 also stores obtaining target information 13b indicating “C” that is the management area 11 for the type information 200 indicating the identification of the person responsible for management corresponding to the type information 320 indicating the identification of the person responsible for management.

The collection control unit 24 refers to the guide 500, reads the obtaining target information 13b indicating the management area 11 that is “A”, the obtaining target information 13b indicating the management area 11 that is “B”, and the obtaining target information 13b indicating the management area 11 that is “C”, and stores them in the obtaining target information memory unit 13a. The data in the management target memory area 11a changes from, for example, “×” to “◯”, and the change monitoring unit 16 detects this change.

The information obtaining unit 13 collects the job-site data 100 indicating the surface temperature of the conveyer from the management area 11 that is “A” upon the detection by the change monitoring unit 16, collects the supplementary information 200 identifying the conveyer from the management area 11 that is “B”, and collects the supplementary information 200 indicating the person responsible for management of the conveyor from the management area 11 that is “C”. Next, the transmitting and receiving unit 14 transmits those job-site data 100 and supplementary information 200 to the event information creating device 1a.

In the event information creating device 1a, the job-site data 100 indicating the surface temperature of the conveyer, the supplementary information 200 identifying the conveyer, and the supplementary information 200 indicating the person responsible for management of the conveyor are stored in the same folder in the element buffer memory 15. The event creating unit 19 takes out these data from the element buffer memory 15, and collects the job-site data 100 indicating the surface temperature of the conveyer, the supplementary information 200 identifying the conveyer, and the supplementary information 200 indicating the person responsible for management of the conveyor as a series of data set, and creates the event information 400 applicable to the model 310 in the dictionary data 300.

(Effects)

As described above, in the information collection system 1 according to this embodiment, the event information creating device 1a stores the dictionary data 300 defining the types of the plurality of data configuring the event information 400 in the dictionary data memory unit 22, and the plurality of type information 320 are transmitted co the data stock device 1b in advance. The data stock device 1b stores the guide 500 for storing the obtaining target information 13b on the memory area in which the data identified by the type information 320 is stored. The information obtaining unit 13 refers to the guide 500, and collects the job-site data 100 and the supplementary information 200 based on the obtaining target information 13b corresponding to the type information 320 with reference to the guide 500. Hence, it is possible to freely create the event information 400 that is the collection of the job-site data 100 and the supplementary information 200 desired by the user, thereby improving the convenience.

### REFERENCE SIGNS LIST

Information collection system
1a Event information creating device
1b Data stock device
1c Dictionary editing device
2 Data occurrence device
3 Database
10 Temporary memory
11 Management area
11a Monitoring target memory area
11b Obtaining target memory area
12 Management destination determining unit
13 information obtaining unit
13a Obtaining target memory
13b Obtaining target information
14 Transmitting and receiving unit
15 Element buffer memory
16 Change monitoring unit
16a Monitoring target memory unit
16b Monitoring target information
17 Transmitting and receiving unit
18 information storing control unit
19 Event creating unit
20 Dictionary data memory unit
21 Editing unit
22 Dictionary data memory unit
23 Collection requesting unit
24 Collection control unit
25 Guide memory unit
100 Job-site data
200 Supplementary information
300 Dictionary data
310 Model
320 Species information
400 Event information
500 Guide
N Network

1. An information collection system comprising a data stock device and an event information creating device connected via a network,
wherein the data stock device comprises:
data storing units that stores data flowing through the network in a prescribed memory area in accordance with types of the data;
monitoring units that monitors a data change in the prescribed memory area of the data storing units;
information obtaining units that collects a plurality of the data stored in the prescribed memory area of the data storing units when the monitoring units detects the data change; and
first transmitting units that transmits the plurality of the data collected by the information obtaining units to the event information creating device, and
wherein the event information creating device comprises:
creating units that collects the plurality of the data received from the data stock device as a series data set to create event information.

2. The information collection system according to claim 1, wherein:
the data stock device comprises monitoring target storing units that stores monitoring target information indicating the prescribed memory area monitored by the monitoring units; and
the monitoring units monitors the data change in the memory area indicated by the monitoring target information.

3. The information collection system according to claim 1 or 2, wherein:
the data stock device comprises obtaining target storing units that stores obtaining target information indicating the prescribed memory area storing data collected by the information obtaining units; and
the information obtaining units obtains all of the data in the memory area indicated by the obtaining target information.

4. The information collection system according to claim 1, wherein:
the event information creating device further comprises:
dictionary storing units that stores dictionary data defining the types of the plurality of the data configuring the event information; and
second transmitting units that transmits, in advance, the type information of the plurality of the data configuring the event information to the data stock device,
the data stock device further comprises:
guide storing units that stores obtaining target information in the memory area storing the data identified by the type information, and
the information collecting units collects the plurality of the data based on the obtaining target information associated with the type information received from the event information creating device.

5. The information collection system according to claim 1, connected to, via the network, a data occurrence device occurring job-site data, and to a database storing supplementary information with various types and various details, wherein:
the data storing units of the data stock device stores the job-site data and the supplementary information in respective prescribed memory area;
the information obtaining units of the data stock device collects one or more of the job-site data and one or more of the supplementary information stored in the prescribed memory area of the data storing units; and
the creating units of the event information creating device collects the one or more of the job-site data and the one or more of the supplementary information received from the data stock device as the series data set to create the event information.

6. The information collection system according to claim 5, wherein:
time stamp data is added to the job-site data; and
the monitoring units of the data stock device monitors a data change in the time stamp data stored in the prescribed memory area in the job-site data stored in the data storing units.

7. The information collection system according to claim 5, wherein:
the data storing units of the data stock device stores the supplementary information indicating a lot number of a product;
the monitoring units monitors the supplementary information indicating the lot number of the product; and
the information obtaining units collects the job-site data relating to a same lot number stored in the prescribed memory area of the data storing units.

8. The information collection system according to claim 5, wherein:
the data storing units of the data stock device stores the supplementary information indicating a model number of a product;
the monitoring units monitors the supplementary information indicating the model number of the product; and
the information obtaining units collects the job-site data relating to the product with a same model number stored in the prescribed memory area of the data storing units.

9. The information collection system according to claim 1, wherein:
the monitoring units of the data stock device monitors a data change in a plurality of the prescribed memory areas of the data storing units; and
the information obtaining units of the data stock device collects a plurality of the data stored in the prescribed memory area of the data storing units when the monitoring units detects any data change.
